(19) United States
(12) Patent Application Publication
(10) Pub. No.: US 2009/0213779 A1
(43) Pub. Date: Aug. 27, 2009

(54) MULTI-HOP WIRELESS RELAY COMMUNICATION SYSTEM AND DOWNLINK DATA TRANSMITTING METHOD AND DEVICE

(76) Inventors: Aimin ZHANG, Shenzhen (CN); Zheng SHANG, Shenzhen (CN); Chengyan FENG, Shenzhen (CN); Jiang LI, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/405,814

(22) Filed: Mar. 17, 2009

Related U.S. Application Data
(63) Continuation of application No. PCT/CN2007/002751, filed on Sep. 18, 2007.

(30) Foreign Application Priority Data
Sep. 18, 2006 (CN) 200610153273.5

(51) Int. Cl. H04B 7/14; H04W 4/00; H04L 12/28; H04B 3/36

(52) U.S. Cl. 370/315; 370/392; 455/7; 370/338

(57) ABSTRACT

A downlink data transmitting method is applied to a multi-hop wireless relay communication system. The method includes the following steps. A network unit obtains an identifier of a next hop network unit corresponding to a connection identifier (CID) in a downlink medium access control protocol data unit (MPDU) header according to an existing corresponding relationship of the CID and a path ID, and sends the downlink MPDU to the next hop network unit by utilizing the obtained identifier of the next hop network unit, so that a data transmission of multi-hop wireless communication system is realized without changing a current user terminal and protocol structure of a core network. Meanwhile, a multi-hop wireless relay system, and a base station and relay stations applied to the system are described.

### CROSS-REFERENCE TO RELATED APPLICATIONS

The application is a continuation of international application No. PCT/CN2007/002751, filed on Sep. 18, 2007, which claims the priority benefit of Chinese patent application No. 200610153273.5, filed on Sep. 18, 2006. The content of the above identified applications are all incorporated herein by reference in their entireties.

### FIELD OF THE INVENTION

The present invention relates to a communication technique field, and more particularly to a multi-hop wireless relay communication system, a downlink data transmitting method, and a device.

### BACKGROUND

In a wireless communication system, by reason of path attenuation of electromagnetic waves or shielding of buildings etc., the wireless communication signal intensity in some regions is relatively lowered, so that the communication quality of mobile user terminals in the regions becomes quite poor. As people's demands for wideband wireless communication are gradually increasing, the demand for the wireless bandwidth becomes larger, and the increasingly higher carrier frequency is used in the new protocols and systems. However, the higher frequency, the higher attenuation is. So high frequency often leads to small coverage of a base station (BS).

In order to solve the problem of the coverage of the BS, usually relay stations (RSs) are adopted to enhance the wireless communication signals between the BS and mobile stations (MSs). The RSs and the BS perform the communication via wireless links without the wired transmission, so as to have low wiring cost and simple deployment. Because of the particularity of some geographical environments, for example, long and narrow regions, when the RS is adopted for forwarding, a plurality of RSs are cascaded to perform a multi-hop transmission.

A structure of a multi-hop wireless communication system having the RSs is shown in FIG. 1. Referring to FIG. 1, the BS is connected with the core network via optical cables or cables, and the coverage of the BS is limited, the BS cannot directly covers MSs1-4, but it covers the MSk via a RSk, in which k is a natural number. No cables are disposed between each RS and the core network for connection, in which the RS1 and the RS2 communicate with the BS via the wireless link, and the RS3 and the RS4 communicate with the BS via the forwarding of the RS2 instead of the direct communication link. For the MS3, the data transmission sent from the BS requires three hops, the first hop is from the BS to the RS2, the second hop is from the RS2 to the RS3, and the third hop is from the RS3 to the MS3.

For sake of convenience, the RS2 and the RS3 are respectively referred to as the first hop RS and the second hop RS of the MS3. In consideration of the service relationship among the BSs, the BS or the RS providing the service for the next hop RS is referred to as a serving station, for example, the BS is the serving station of the RS1 and the RS2, and the RS2 is the serving station of the RS3 and the RS4. If the BS and the RS are considered as the nodes in the topology network, after the connection is established, the serving RS of a certain RS and the node of the upstream are referred to as the upstream nodes of the RS, and the next hop node of the RS till the node providing the service to the user terminal are referred to as the downstream nodes.

The air interface of a worldwide interoperability for microwave access (WiMAX) system adopts the IEEE 802.16 standard, and the 802.16 standard regulates that a medium access control protocol data unit (MPDU) is composed of a header and a load. The header includes a connection identifier (CID). The CID is adapted to identify the connection between the BS and an equivalent entity on a medium access control (MAC) layer of the user terminal, and is composed of 16 bits. The load of the MPDU may bear the signaling or the service data. The CID of the MPDU bearing the signaling and the CID of the MPDU bearing the service data are unified addressed, but are located in different intervals.

During a process that the user terminal gets access to the network, the BS allocates a basic CID and a primary management CID to the user terminal, and further allocates a secondary management CID to the manageable user terminal. For the user terminal, the three CIDs used by the uplink signaling and downlink signaling are the same, so that it may be considered that the BS allocates three pairs of CIDs to the user terminal. If the user terminal does not experience handover, the three pairs of CIDs are always used by the user terminal without being released. In the same cell, different user terminals have different basic CIDs, different primary management CIDs, and different secondary manage CIDs. The three pairs of CIDs are adapted to identify the signaling sent from the user terminal or the signaling sent from the BS to the user terminal, and referred to as the signaling CIDs for being distinguished from the service data CIDs below.

A service data transmission is different from a signaling transmission. Uplink and downlink service flows (SFs) are different service flows identified by different service flow identifiers (SFIDs), and each SFID is associated with one service data CID. The SFID is adapted to uniquely identify one SF, the parameter of an SF including a source address, a destination address, and a port number, and an SF shall satisfy certain quality of service (QoS). When the user terminal is handed over from one BS to another BS, for the same SF, the SFID is not changed, but the CID associated with the SFID is changed. The associated CID may include the signaling CID or the service data CID, or may include the signaling CID and the service data CID, which are referred to as the CIDs below. The BS and the user terminal establish the service connection through a dynamic service addition request (DSA-REQ) message, a dynamic service addition response (DSA-RSP) message, and a dynamic service addition acknowledgement (DSA-ACK) message. The parameters of the service connection are changed by negotiation through a dynamic service change request (DSC-REQ) message, a dynamic service change response (DSC-RSP) message, and a dynamic service change acknowledgement (DSA-ACK) message. The service connection is deleted through a dynamic service deletion request (DSD-REQ) message and a dynamic service deletion response (DSD-RSP). The messages are signaling messages, and the CIDs bearing these messages in the headers of the MPDUs are the primary management CIDs.

The addition, change, and deletion requests of the service connection may be initiated by the BS or the user terminal.

The process of the addition of the service connection initiated by the BS includes the steps as follows.

(1) The BS sends to the user terminal the DSA-REQ message including the SFID and the CID of the SF to be established. (2) After receiving the DSA-REQ message, the user terminal responds the DSA-RSP message to the BS. (3) After receiving the DSA-RSP message, the BS sends the DSA-ACK message for acknowledgement to the user terminal.

The process of the change of the service connection initiated by the BS includes the steps as follows. (1) The BS sends the DSC-REQ message including the SFID to the user terminal. (2) After receiving the DSC-REQ message, the user terminal responds the DSC-RSP message to the BS. (3) After receiving the DSC-RSP message, the BS sends the DSC-ACK message for acknowledgement to the user terminal.

The process of the deletion of the service connection initiated by the BS includes the steps as follows. (1) The BS sends to the user terminal the DSD-REQ message including the SFID of the SF to be deleted. (2) After receiving the DSD-REQ message, the user terminal responds the DSD-RSP message including the SFID to the BS.

The process of the addition of the service connection initiated by the user terminal includes the steps as follows. (1) The user terminal sends the DSA-REQ message to the BS. (2) After receiving the DSA-REQ message, the BS responds to the user terminal the DSA-RSP message including the SFID and the CID allocated to the SF. (3) After receiving the DSA-RSP message, the user terminal sends the DSA-ACK message for acknowledgement to the BS.

The process of the modification of the service connection initiated by the user terminal includes the steps as follows. (1) The user terminal sends to the BS the DSC-REQ message including the SFID of the connection to be changed. (2) After receiving the DSC-REQ message, the BS responds the DSC-RSP message including the SFID to the user terminal. (3) The user terminal sends the DSC-ACK message for acknowledgement.

The process of the deletion of the service connection initiated by the user terminal includes the steps as follows. (1) The user terminal sends to the BS message the DSD-REQ message including the SFID of the SF to be deleted. (2) After receiving the DSD-REQ message, the BS responds the DSD-RSP message including the SFID to the user terminal.

The current WiMAX technique only considers the situation that the BS and the user terminal has the direct physical connection, but does not provide the multi-hop transmitting method, so that the current WiMAX technique may not directly support the multi-hop data transmission as shown in FIG. 1.

### SUMMARY

Accordingly, various embodiments of the present disclosure provide a multi-hop wireless relay communication system, a downlink data transmitting method, and a device, so as to solve the problem of the multi-hop wireless relay communication system in the prior art that the multi-hop data transmission cannot be realized.

One embodiment of the present disclosure provides a downlink data transmitting method, which is applied to a multi-hop wireless relay communication system, and includes the steps as follows.

A network unit obtains an ID of a next hop network unit corresponding to a CID in a downlink MPDU header according to an existing corresponding relationship of the CID and a path ID, and sends the downlink MPDU to the next hop network unit by utilizing the obtained ID of the next hop network unit.

Another embodiment of the present disclosure provides a multi-hop wireless relay system, which includes a BS and more than one RS.

The BS is adapted to obtain a next hop relay station ID (RSID) corresponding to a CID in a downlink MPDU according to an existing corresponding relationship of the CID and the next hop RSID, and send the downlink MPDU to the next hop RS according to the obtained next hop RSID.

The RS is adapted to obtain the next hop RSID corresponding to the CID in the received downlink MPDU header according to the existing corresponding relationship of the CID and the next hop RSID, and send the downlink MPDU to the next hop RS till a user terminal according to the obtained next hop RSID.

Another embodiment of the present disclosure provides a communication device, applied to a multi-hop wireless relay system, the communication device is a base station (BS) or a relay station (RS), comprising:

a routing device, adapted to obtain an identifier (ID) of a next hop network unit corresponding to a connection ID (CID) in a downlink medium access control protocol data unit (MPDU) header according to an existing corresponding relationship of the CID and the path ID, and send the downlink MPDU to the next hop network by utilizing the obtained ID of the next hop network.

According to various embodiments of the present disclosure, the data transmission of the multi-hop wireless communication system can be supported without changing a current user terminal and protocol structure of a core network.

### BRIEF DESCRIPTION OF THE DRAWINGS

The present invention becomes more fully understood from the detailed description given herein below for illustration only and by referring to the accompanying drawings among which:

FIG. 1 is a structural view of a multi-hop wireless relay communication system in the prior art;

FIG. 2 is a schematic flow chart of a downlink data transmission according to an embodiment of the present disclosure;

FIG. 3 is a schematic flow chart of a route update performed by a BS according to the embodiments of the present disclosure;

FIGS. 4a and 4b show schematic flow charts of the route update performed by the BS according to the embodiments of the present disclosure;

FIG. 5 is a schematic view of receiving a route update message by an RS and corresponding processes according to the embodiments of the present disclosure;

FIGS. 6a and 6b show schematic flow charts of the route update performed by the RS according to the embodiment of the present disclosure;

FIG. 7 is a schematic structural view of a system according to a first embodiment of the present disclosure;

FIG. 8 is a schematic view of saved information in route databases of the BS and each RS after the first route update in the embodiment as shown in FIG. 7;

FIG. 9 is a schematic view of the saved information in the route databases of the BS and each RS after the second route update in the embodiment as shown in FIG. 7;

FIG. 10 is a schematic structural view of the system according to a second embodiment of the present disclosure;

FIG. 11 is a schematic structural view of the BS according to the embodiment of the present disclosure;

FIG. 12 is a schematic structural view of the RS according to the embodiment of the present disclosure; and

FIG. 13 is a schematic view of the saved information in the route database according to the embodiment of the present disclosure.

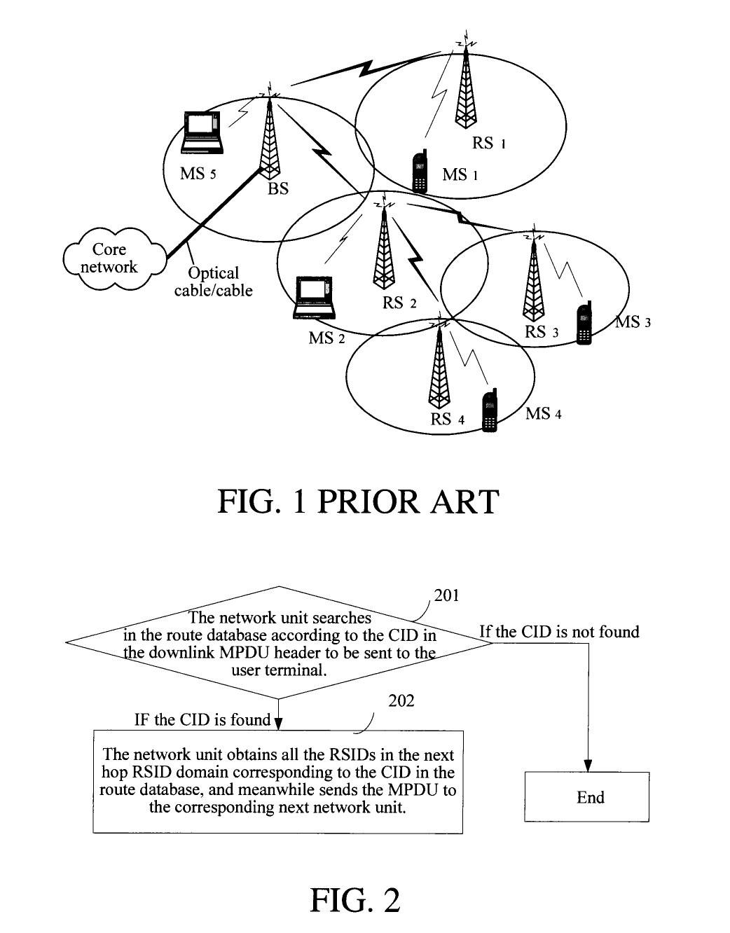

### DETAILED DESCRIPTION OF THE EMBODIMENTS

In various embodiments of the present disclosure, a network unit obtains an ID of a next hop network unit corresponding to a CID in a downlink MPDU header according to an existing corresponding relationship of the CID and the ID of the next hop network unit, and sends the downlink MPDU to the next hop network unit by utilizing the obtained ID of the next hop network unit.

The network unit includes a BS and one or more RS, a first node of a downlink data transmission may be the BS, the next hop network unit of the BS may be a user terminal or the RS, and next hop network unit of the RS may be the user terminal or the RS.

The BS and each RS respectively corresponds to one database adapted to save the corresponding relationship of the CID and the ID of the next hop network unit.

In various embodiments of the present disclosure, the ID of the next hop network unit is represented by a next hop RSID, that is, the next hop network units are represented by utilizing the different IDs. For example, if the next hop RSID is null, the next hop network unit is the user terminal, and if the next hop RSID is a non-null value, the value represents the next hop RSID.

Table 1 is a schematic view of a storing format of a route database according to the embodiments of the present disclosure. Referring to Table 1, in the embodiments of the present disclosure, the route database is composed of three domains, including a next hop RS domain, a path ID domain, and a CID domain. The next hop RS domain is adapted to store the next hop RSID and a number of the next hop RSs, the path ID domain is adapted to store the path IDs passing the current node and a number of the paths, and the CID domain is adapted to store the CID passing each path and a number of the CIDs. The path refers to an ordered set of all the RSs where the connection from the BS to a certain user terminal passes. One ID is allocated to each path, which is referred to as a path ID. The BS needs to maintain the information of all the paths, including the path IDs, all the RSIDs of the path, and the set of all the CIDs transmitted on the path. When the BS initiates a route update process and receives a route update acknowledgement, the corresponding information of the path is updated.

TABLE 1

| Syntax | Comments |
|---|---|
| RSID_Num | A number of the RSIDs of a next hop |
| for i = 1 to RSID_Num | |
| { | |
| RSIDi | 0xff represents the null RSID |
| Path_Num | A number of the paths passing an i^{th} next |
| | hop RS |
| for j = to Path_Num | |
| { | |
| PathIDj | |
| CID_Num | A number of the CIDs passing the path PathIDj |
| for k = 1 to | |
| CID_Num | |
| { | A list of the CIDs passing the path PathIDj |
| CIDk | |
| } | |
| } | |
| } | |

In various embodiments of the present disclosure, the BS and each RS of the BS respectively save the route database as shown in Table 1, each route database stores the corresponding relationship of the CID and the path ID, and the corresponding relationship of each path ID and the next hop RSID. Each RS may find the next hop RSID by utilizing the CID. In Table 1, the path ID domain is saved, and the path ID domain enables the route database to be correctly maintained, instead of being used during the practical downlink data transmission process.

Referring to FIG. 13, the route database of the embodiments of the present disclosure saves the corresponding relationship of the CID and the Path ID, and the corresponding relationship of the path ID and the next hop RSID. The CID corresponds to at least one path ID, and each path ID corresponds to the next hop RSID. For example, as shown in FIG. 13, the CID C01 is corresponding to the path ID P01, and the ID in the next hop RS domain corresponding to the path ID is null. The CID C02 is corresponding to two paths, the path IDs are respectively P01 and P02, and the next hop RSIDs corresponding to the path IDs P01 and P02 are null. The CID C11 is corresponding to two paths, the path IDs are respectively P11 and P13, the next hop RSID corresponding to the P11 is RS1, and the next hop RSID corresponding to the P13 is also RS1. The CID Cm1 is corresponding to two paths, the path IDs are respectively P12 and Pm2, the next hop RSID corresponding to P12 is RS1, and the next hop RSID corresponding to Pm2 is RSm.

Referring to FIG. 2, in one embodiment of the present disclosure, the process of realizing the downlink data transmission by utilizing the route database as shown in Table 1 is described in detail as follows.

In Step 201, the network unit searches in the CID domain of the route database according to the CID in the downlink MPDU header to be sent to the user terminal, and judges whether the CID domain has the CID, if no, it indicates that the route fails, and the flow is end, and if the route database has the CID, Step 202 is performed.

In Step 202, the network unit obtains all the RSIDs in the next hop RSID domain corresponding to the CID in the route database, and sends the MPDU to the corresponding next network unit by utilizing the RSID.

The next hop RSID may be the null RSID, and may also have one or more RSIDs. If the next hop RS domain is the null RSID, the network unit sends the MPDU to the corresponding user terminal in the cell; otherwise, sends the MPDU to one or more corresponding next hop RSs.

After receiving the data packet sent from the destination hop network unit, the RS forwards the data packet to the next hop RS, the route database provides the correct route data, so as to ensure that the data is correctly routed. Therefore, the route update in the route database is quite important.

Referring to Table. 2, in one embodiment of the present disclosure, a format of the route update message is defined. The route update message of the embodiment of the present disclosure includes a route update message type, an operation serial number, route update indication information, and route information to be added or deleted according to different route update indication information. The route information to be added or deleted includes the path ID passing the node of itself, and the CID corresponding to each path ID.

TABLE 2

| Syntax | Bits | Comments |
|---|---|---|
| Message Type = RtUpdate | 8 | The route update message type |
| Transaction ID | 16 | The operation serial number |
| Route_Update_Indicator | 2 | The route update indication information |
| | | Bit#0 = 1 the message includes the newly |
| | | added path |
| | | Bit#1 = 1 the message includes the path to be |
| | | deleted |
| if(Route_Update_Indicator[0] = 1) | | |
| { | | Including the newly added path |
| Add_Path_Num | 4 | A number of the paths to be added |
| for i = 1 to Add_Path_Num | | |
| { | | |
| Add_Path_Indicator | 2 | Bit#0 = 1 the added path is a new path, and the |
| | | new path is generated by utilizing the original |
| | | path ID |
| | | Bit#1 = 1 the increased path is a new path, and |
| | | includes the detailed path information |
| | | Bit#0 = 0, Bit#1 = 0 the CID is added to the |
| | | original path, or the added path is a new path, |
| | | the original path ID is not utilized, and the |
| | | detailed path information does not exist (the |
| | | situation occurs when the next hop of the |
| | | route update message is a destination node) |
| Add_PathIDi | 8 | The ID of the added path |
| Add_CID_Num | 4 | |
| for j = 1 to Add_CID_Num | | A list of the CIDs having the same path |
| { | | |
| Add_CIDj | 16 | |
| } | | |
| if (Add_Path_Indicator[0] | | |
| = 1) | | |
| { | | |
| Overlapped_PathID | 8 | The overlapped parts of the new path and the |
| | | old path |
| } | | |
| if (Add_Path_Indicator[1] | | The detailed path |
| = 1) | | |
| { | | |
| Add_RSID_Num | 4 | The number of the RSIDs in the detailed list |
| | | of the path RSID |
| for j = 1 to | | |
| Add_RSID_Num | | |
| { | | The detailed list of the path RSID |
| Add_RSIDj | 6 | |
| } | | |
| } | | |
| } | | |
| } | | |
| if(Route_Update_Indicator[1] = 1) | | |
| { | | Including the path to be deleted |
| Del_Path_Num | 4 | The number of the paths to be deleted |
| for i = 1 to Del_Path_Num | | The list of the paths to be deleted |
| { | | |
| Del_Path_Indicator | 2 | 0x0 delete the whole path |
| | | 0x1 delete the given CID in the corresponding |
| | | path |
| | | 0x2 delete all the CIDs except for the given |
| | | CID in the corresponding path |
| | | 0x3 delete all the CIDs of the corresponding |
| | | path, but reserve the path |
| Del_PathIDi | 12 | The path ID to be deleted |
| if(Del_Path_Indicator = | | |
| 0x1) | | |
| { | | |
| Del_CID_Num | 4 | The number of the CIDs to be deleted |
| | | corresponding to the path ID |
| for j = 1 to | | |
| Del_CID_Num | | |
| { | | The list of the CIDs to be deleted |
| | | corresponding to the path ID |
| Del_CIDj | | |
| } | | |
| } | | |
| else if(Del_Path_Indicator | | |
| = 0x2) | | |
| { | | |
| Keep_CID_Num | 4 | The number of the CIDs to be reserved |
| | | corresponding to the path ID |
| for j = 1 to | | |
| Keep_CID_Num | | |
| { | | The list of the CIDs to be reserved |
| | | corresponding to the path ID |
| Keep_CIDj | | |
| } | | |
| } | | |
| } | | |
| } | | |
| Padding bits | | The padding bits enable the whole message |
| | | length to be an integral byte |

Referring to Table. 3, in one embodiment of the present disclosure, a format of the route update acknowledgement message is defined. The route update acknowledgement message includes a route update feedback message type, an operation serial number, route update feedback indication information, and feedback information on the newly added or the deleted path.

TABLE 3

| | Bits | Comments |
|---|---|---|
| Message Type = RtUpdateFeedback | 8 | The route update feedback message |
| | | type |
| Transaction ID | 8 | The operation serial number |
| RtUpdate_Feedback_Indicator | 2 | The route update feedback indication |
| | | information |
| | | Bit#0 = 1 the message includes the |
| | | feedback on the newly added path |
| | | Bit#1 = 1 the message includes the |
| | | feedback on the deleted path |
| if(RtUpdate_Feedback_Indicator[0] = | | |
| 1) | | |
| { | | The message includes the feedback on |
| | | the newly added path |
| Add_Path_Num | 4 | The feedback message includes the |
| | | number of the paths |
| for i = 1 to Add_Path_Num | | |
| { | | |
| Add_PathIDi | 8 | The path ID is added |
| Add_Status | 1 | The feedback on the added path ID |
| If(Add_Status = NAK) | | |
| { | | |
| Add_Bitmap | Variable | Feedback is given on each CID, a |
| | | Bitmap length is equal to the length of |
| | | the corresponding list of the CIDs in |
| | | the route update message |
| for i = 1 to | | #NAKsInAddBitmap represents the |
| #NAKsInAddBitmap | | number of NAKs in Add_Bitmap |
| { | | |
| Add_Error_Code | 2 | A corresponding error code is given to |
| | | the NAK message |
| } | | |
| } | | |
| } | | |
| } | | |
| if(RtUpdate_Feedback_Indicator[1] = | | |
| 1) | | |
| { | | The message includes the feedback on |
| | | the deleted path |
| Del_Path_Num | 4 | |
| for j = 1 to Del_Path_Num | | |
| { | | |
| Del_PathIDj | 8 | The deleted path ID |
| Del_Status | 1 | The feedback on the deleted path ID |
| If(Del_Status = NAK) | | |
| { | | |
| Del_Bitmap | Variable | Feedback is given on each CID, and |
| | | the Bitmap length is equal to the |
| | | length of the corresponding list of the |
| | | CIDs in the route update message |
| for i = 1 to | | #NAKsInDelBitmap represents the |
| #NAKsInDelBitmap | | number of NAKs in Del_Bitmap |
| { | | |
| Del_Error_Code | 2 | The corresponding error code is given |
| | | to the NAK message |
| } | | |
| } | | |
| } | | |
| } | | |
| Padding bits | | The padding bits enable the whole |
| | | message length to become the integral |
| | | byte |

The update of the route databases corresponding to the BS and the RS may be realized in the manner as follows.

The BS sends a route update message to the next hop RS, and updates the corresponding route database thereof by utilizing the route update message. The route update message includes the information of the next hop RS till the destination station where the connection of the user terminal passes, and the connection state of the user terminal is changed. The RS receiving the route update message updates the corresponding route database thereof by utilizing the received route update message, deletes the information of the network unit of itself in the received route update message, and generates and sends a new route update message to the next hop RS till the destination station.

After receiving the route update message, the destination station generates a route update acknowledgement message including a route update result, and sends the route update acknowledgement message to the destination hop RS. The RS receiving the route update acknowledgement message forwards the route update acknowledgement message to the destination hop RS till the BS.

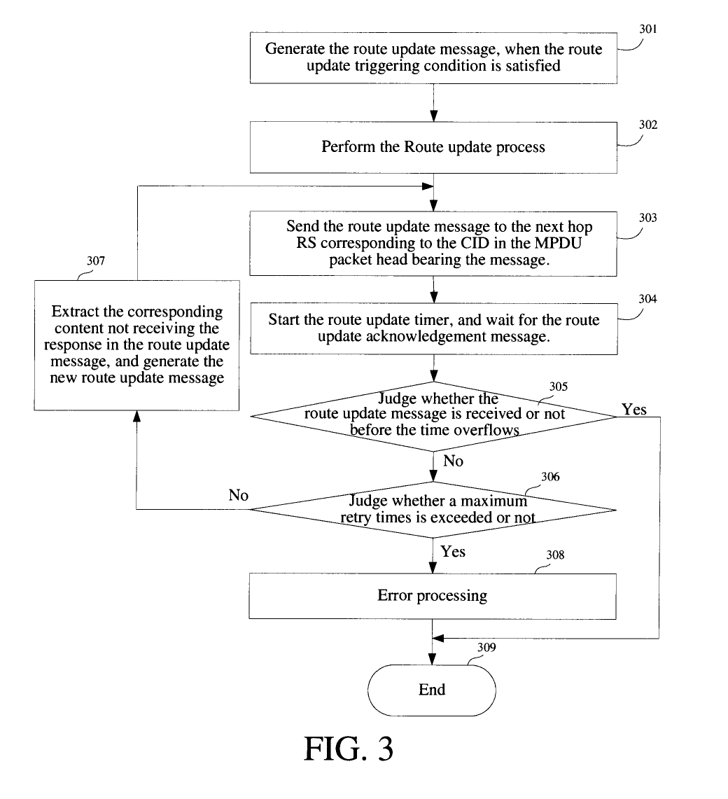

Referring to FIG. 3, the processing flow of the route update performed by the BS includes the steps as follows in detail.

In Step 301, when the route update triggering condition is satisfied, the route update message is generated.

The process of determining whether the route update triggering condition is satisfied may be realized as follows. It is judged whether the connection of the user terminal corresponding to the downlink MPDU to be sent is changed or not, if yes, it is determined that the route update triggering condition is satisfied; otherwise, it is determined that the route update triggering condition is not satisfied. Here, the user terminal corresponding to the downlink MPDU is the destination terminal of the downlink MPDU.

The route update triggering condition is that the BS receives a ranging request message sent from the user terminal, and allocates a basic CID and a primary management CID to the user terminal; or the BS receives a registration request message sent from the user terminal and allocates the secondary management CID to the user terminal; or the BS receives an SF adding response message or an SF deleting response message sent from the user terminal; or the BS sends the SF adding response message or the SF deleting response message to the user terminal; or during the handover process, the BS judges that the handover of the user terminal is successful; or the BS inspects that the terminal is disconnected; or the terminal deregisters from the BS.

According to different triggering conditions, the route update message includes two types: one is the route update message performing the route adding, and the other is the route update message performing the route deletion. In order to reduce the number of the route update messages, when several route update messages include the common information, the BS may gather the plurality of route update messages into one route update message.

The triggering condition of generating the route update message by the BS is that the BS receives the ranging request message sent from the user terminal, and allocates the basic CID and the primary management CID to the user terminal; or the BS receives the registration request message sent from the user terminal and allocates the secondary management CID to the user terminal; or the BS receives the SF adding response message or the SF deleting response message sent from the user terminal; or the BS sends the SF adding response message or the SF deleting response message to the user terminal; or during the handover process, the BS judges that the handover of the user terminal is successful; or the BS inspects that the user terminal is disconnected; or the terminal deregisters from the BS.

After receiving the ranging request (RNG-REQ) message sent from the user terminal, the BS allocates the basic CID and the primary management CID to the user terminal, here, the BS needs to generate the route update message performing the route adding.

After sending a dynamic service adding request (DSA-REQ) message to the user terminal, if the BS receives a dynamic service adding response (DSA-RSP) message from the user terminal, the DSA-RSP message is transmitted with the primary management CID of the user terminal, that is, the CID domain bearing the MPDU header of the message is the primary management CID of the terminal. The DSA-REQ message corresponding to the DSA-RSP includes the service CID allocated by the BS to the user terminal, and the service CID is different from the basic CID, the primary management CID, and the secondary management CID etc. of the user terminal. Here, the BS needs to generate the route update message performing the route adding.

After sending a dynamic service deletion request (DSD-REQ) message to the user terminal, if the BS receives a dynamic service deletion response (DSD-RSP) message from the user terminal, the DSA-RSP message is transmitted with the primary management CID of the user terminal. The DSA-RSP message includes the SFID corresponding to a certain service CID. The BS obtains the corresponding service CID by searching for the corresponding relationship of the SFID and the service CID. Here, the BS needs to generate the route update message performing the deletion operation.

When the BS sends a registration response (REG-RSP) message to the user terminal, the message includes the secondary management CID allocated by the BS to the terminal. The BS firstly judges whether the terminal is managed or not, and if no, the route update message is not generated; otherwise, the route update message for performing the route adding is generated.

The BS sends the DSA-RSP message to the user terminal. The DSA-RSP message sent from the BS includes the service CID allocated to the user terminal, and here the BS needs to generate the route update message performing the route adding.

The BS sends the DSD-RSP message to the user terminal. The DSD-RSP message sent from the BS includes the SFID to be uploaded, and the BS searches for the service CID corresponding to the SFID, and then generates the route update message performing the route adding.

After finding that the handover of the user terminal is successful, the service BS needs to generate the route update message. The service BS receives a handover indication (MOB_HO-IND) message sent from the user terminal. A handover indication type (HO_IND-type) domain in the message indicates the type of the message, and totally three types exist, namely, releasing the service BS, canceling the handover, and rejecting the handover. If the handover indication type is the “releasing the service BS”, it represents that the user terminal is handed over from the BS, and at this time, the service BS starts a timer that is referred to as a resource maintaining timer. If the handover indication message with the type being MOB_HO-IND is not received before the resource maintaining timer overflows, the BS considers that the handover of the user terminal is successful. If before the timer overflows, the service BS receives the information showing that the handover of the user terminal is successful sent from the destination BS, the BS considers that after the handover of the user terminal is successful, the route relationships of all the connections related to the user terminal may be deleted. The BS needs to generate the route update message performing the route deletion.

For example, after allocating the uplink resource to a certain user terminal for several times, the BS does not receive the signal of the user terminal, it may be judged that the terminal is disconnected. After the BS inspects that a certain user terminal is disconnected, the BS deletes the route relationships of all the connections related to the user terminal, and the BS needs to generate the route update message performing the route deletion.

When the user terminal deregisters from the system, the route update message is generated. Several methods for enabling the terminal to deregister from the system exist, and the terminal deregistration may be initiated by the terminal or the BS. For example, in a deregistration process initiated by the terminal, the terminal sends a deregistration request (DREG-REQ) message including a deregistration request code (De-Registration-Request-Code) of 0x01. After receiving the message, the BS sends a deregistration command (DREG-CMD) to the terminal, and meanwhile starts a management resource holding timer (Management_Resource_Holding_Timer), after the resource holding timer overflows, the BS releases all the connections allocated to the terminal.

In Step 302, the BS performs a route update process according to the route update message.

In Step 303, the BS sends the route update message to the corresponding next hop RS.

In Step 304, the BS starts the route update timer, and waits for the route update acknowledgement message.

In Step 305, it is judged whether the BS receives the route update acknowledgement message or not before the time overflows, and if yes, Step 309 is performed; otherwise, Step 306 is performed.

In Step 306, the BS judges whether a maximum retry times is exceeded or not, and if yes, Step 308 is performed; otherwise, Step 307 is performed.

In Step 307, the BS extracts the corresponding content not receiving the response in the route update message, generates the new route update message, and Step 303 is performed.

In Step 308, error processing.

In Step 309, the flow is end.

The route update process in Step 302 includes the route adding process and the route deletion process.

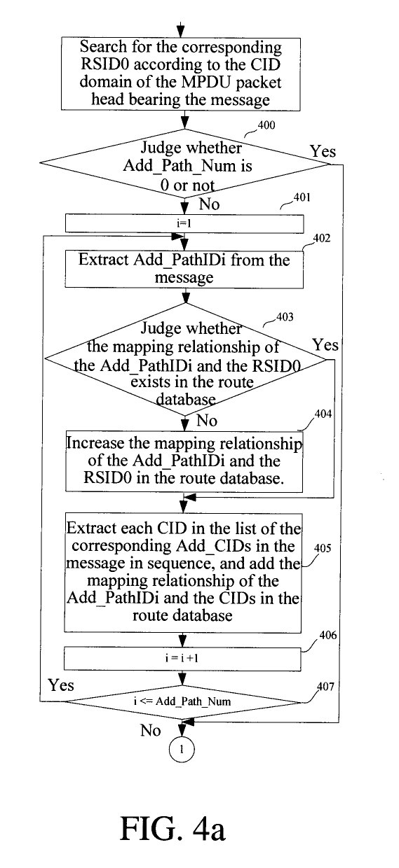

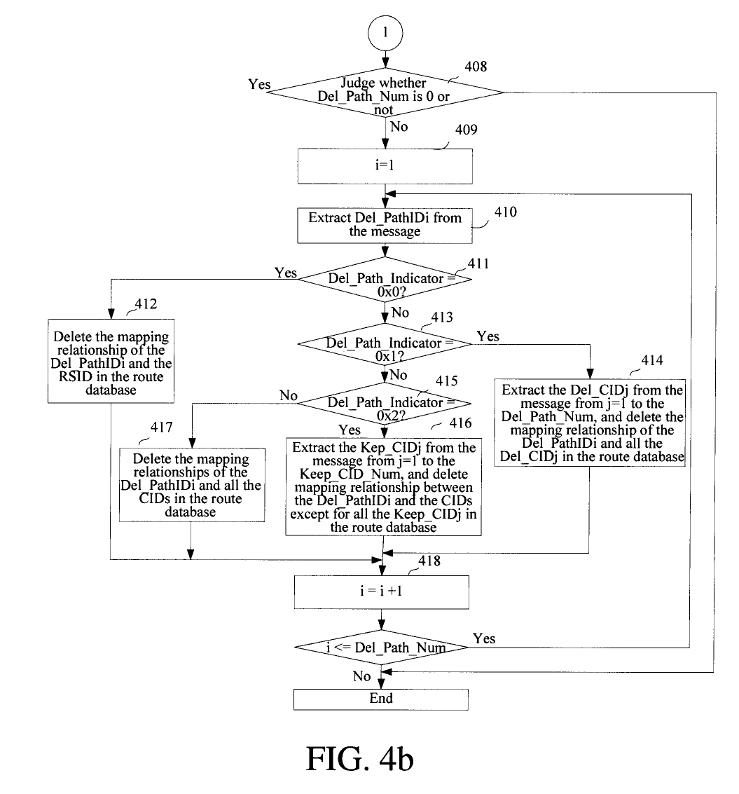

Referring to FIG. 4, the detailed flow of the route update process performed by the BS is described as follows.

In Step 400, it is judged whether the route update message includes the newly added path or not, and if yes, Step 401 is performed; otherwise, Step 408 is performed.

In Step 401, it is set that i=1.

In Step 402, the ith path ID to be added is extracted from the route update message, and is set to Add_PathIDi.

In Step 403, it is judged whether the corresponding relationship of the Add_PathIDi and the next hop RSID exists in the route database, and if yes, Step 405 is performed.

In Step 404, the corresponding relationship of the Add_PathIDi and the next hop RSID is added in the route database.

In Step 405, the list of the corresponding CIDs to be added is extracted in sequence, and the corresponding relationship of the Add_PathIDi and the CIDs is added in the route database.

In Step 406, it is set that i=i+1.

In Step 407, if i<=the number of the paths to be added, Step 402 is performed, and if i>CID_Num, Step 408 is performed.

In Step 408, it is judged whether the route update message includes the paths to be deleted or not, and if yes, Step 409 is performed; otherwise, the flow is end.

In Step 409, it is set that i=1.

In Step 410, the ith path ID to be deleted is extracted from the route update message, and is set to Del_PathIDi.

In Step 411, it is judged whether the whole path corresponding to the Del_PathIDi is deleted or not according to the route update message, and if no, Step 413 is performed; otherwise, Step 412 is performed.

In Step 412, the corresponding relationship of the Del_PathIDi and the RSID is deleted in the route database, and Step 418 is performed.

In Step 413, it is judged whether the corresponding relationship of the Del_PathIDi and the list of the CIDs in the route update message is deleted or not according to the route update message, and if no, Step 415 is performed.

In Step 414, the corresponding relationship of the Del_PathIDi and the list of the CIDs in the route update message are deleted, and Step 418 is performed.

In Step 415, it is judged whether the corresponding relationships of the Del_PathIDi and other CIDs except for the list of the CIDs in the route update message are deleted or not according to the route update message, and if yes, Step 416 is performed; otherwise, Step 417 is performed.

In Step 416, the corresponding relationships between the Del_PathIDi and other CIDs except for each Keep_CID in the list of the CIDs in the route update message are deleted, and Step 418 is performed.

In Step 417, the corresponding relationships of the Del_PathIDi and all the CIDs in the route database are deleted.

In Step 418, it is set that i=i+1, if i<=the number of the paths to be added, Step 410 is performed, otherwise, the flow is end.

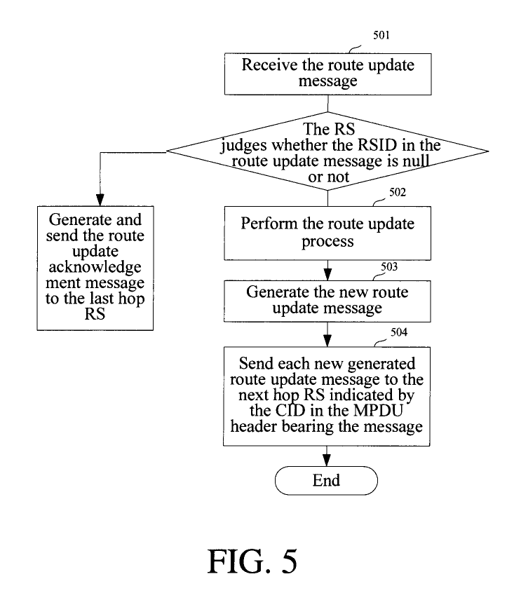

Referring to FIG. 5, the processing flow after the RS receives the route update message is described as follows.

In Step 501, the RS receives the route update message, and judges whether the RSID in the route update message is null or not, and if yes, the RS generates the route update acknowledgement message, and sends the route update acknowledgement message to the destination hop RS, otherwise, Step 502 is performed.

In Step 502, the RS updates the corresponding route database thereof by utilizing the received route update message.

The process of updating the corresponding route database thereof by the RS includes the steps as follows. According to the route update message, it is determined whether the update is the route adding operation or the deletion operation. If it is the adding operation, it is judged whether the route update message includes the newly added path or not, and if yes, the newly added path is added to the route database. If it is the deletion operation, it is judged whether the route update message includes the paths to be deleted or not, and if yes, the related path in the route database is deleted according to the route update message.

In Step 503, the RS deletes the information of the network unit itself in the received route update message, and generates the new route update message.

The process of generating the new route update message is described in detail as follows.

The RS deletes the information of the network unit itself in the received route update message, and determines whether the paths pass the same next hop RS according to the next hop RS of each path in the route update message. If no, one new route update message is generated for each different next hop RS; otherwise, only one new route update message is generated. In the new route update message, except for the route information of this hop, the content is the same as the original route update message, and the format of the new route update message is similar to the format of the original route update message.

In Step 504, the RS sends the route update message generated by itself to the corresponding next hop RS, and the flow is ends.

When receiving the route update acknowledgement message, each RS forwards the route update acknowledgment message to its superordinate nodes, until the message is received by BS.

The process of performing the route update in Step 502 includes the route adding process and the route deletion process.

In the route adding process, it is judged whether the route update message includes the newly added path or not, and if yes, the newly added path is added to the route database.

In the route deletion process, it is judged whether the route update message includes the paths to be deleted or not, and if yes, according to the route update message, the related path in the route database is deleted, otherwise, the flow is end.

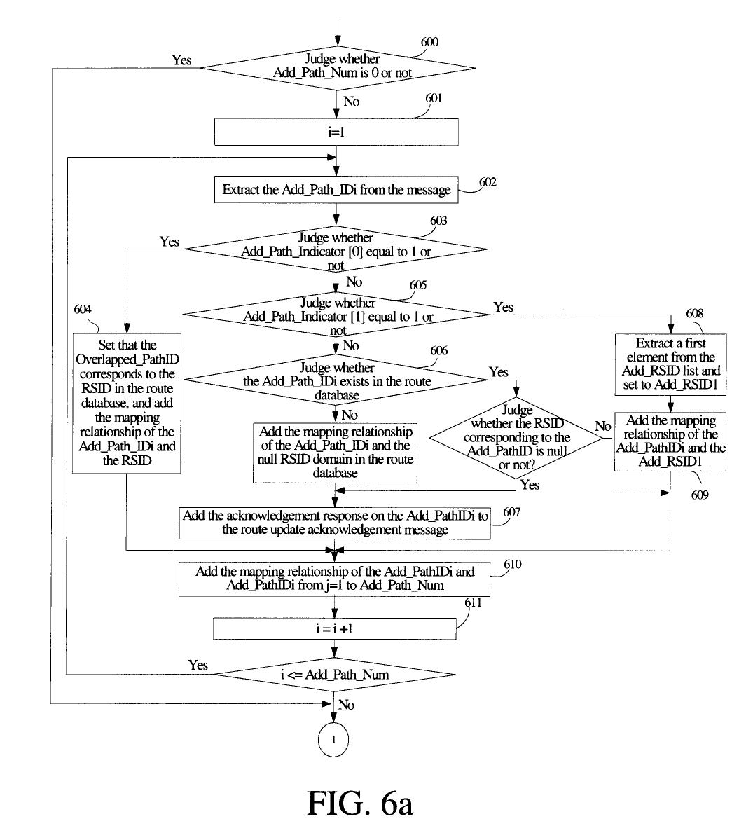

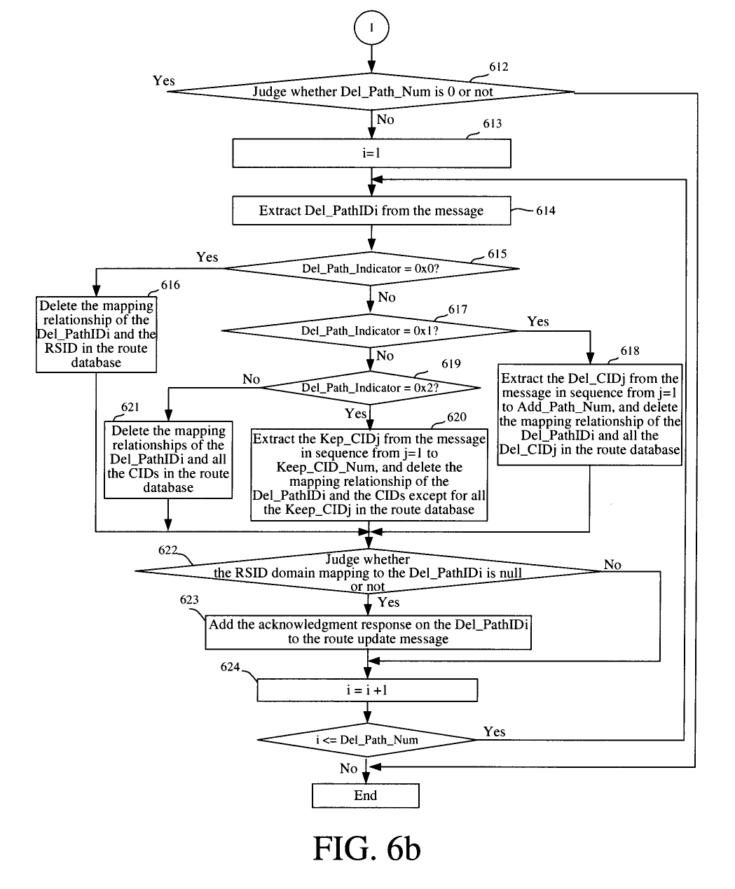

Referring to FIG. 6, the route update process includes the steps as follows.

In Step 600, it is judged whether the route update message includes the newly added path or not, and if yes, Step 601 is performed, otherwise, Step 612 is performed.

In Step 601, it is set that i=1.

In Step 602, the ith path ID to be added is extracted from the route update message, and is set to Add_PathIDi.

In Step 603, it is judged whether the route update message includes the overlapped information of the new path and the original path for Add_PathIDi, and if no, Step 605 is performed.

In Step 604, the RSID corresponding to the original path is obtained by searching in the route database, then the corresponding relationship of the Add_PathIDi and the RSID is added, and Step 610 is performed.

In Step 605, it is judged whether the route update message includes the detailed path information or not for the Add_PathIDi, and if yes, Step 608 is performed.

In Step 606, it is judged whether the route database has the Add_PathIDi, if not, the corresponding relationship of the Add_PathIDi and the null RSID is created, if yes, it is judged whether the Add_PathIDi corresponds to the null RSID, and Step 610 is performed if the Add_PathIDi does not correspond to the null RSID.

In Step 607, the acknowledgement response on the Add_PathIDi is added to the route update acknowledgement message, and Step 610 is performed.

In Step 608, a first element is extracted from the detailed list of the paths, and is set to Add_RSID1.

In Step 609, the corresponding relationship of the Add_PathIDi and the Add_RSID1 is added.

In Step 610, the corresponding relationship of the Add_PathIDi and the corresponding CID to be added in the route update message is added.

In Step 611, it is set that i=i+1, and if i<=the number of the paths to be added Add_Path_Num, Step 602 is performed; otherwise, Step 612 is performed.

In Step 612, according to whether the Del_Path_Num in the route update message is 0 or not, it is determined whether the route update message includes the paths to be deleted, and if the route update message includes the paths to be deleted, Step 613 is performed; otherwise, the flow is end.

In Step 613, it is set that i=1.

In Step 614, the ith path ID to be deleted is extracted from the route update message, and is set to Del_PathIDi.

In Step 615, it is judged whether the path corresponding to the whole Del_PathIDi is deleted or not according to the route update message, and if the path corresponding to the whole Del_PathIDi is deleted, Step 616 is performed; otherwise, Step 617 is performed.

In Step 616, the corresponding relationship of the Del_PathIDi and the RSID in the route database is deleted, and Step 622 is performed.

In Step 617, it is judge whether the corresponding relationship of the Del_PathIDi and the list of the CIDs in the route update message is deleted or not according to the route update message, and if the corresponding relationship of the Del_PathIDi and the list of the CIDs in the route update message is deleted, Step 618 is performed; otherwise, Step 619 is performed.

In Step 618, the corresponding relationship of the Del_PathIDi and each Del_CID in the list of the CIDs in the route update message is deleted, and Step 622 is performed.

In Step 619, it is judged whether the corresponding relationships of the Del_PathIDi and other CIDs except for the list of the CIDs in the route update message are deleted or not according to the route update message, and if the corresponding relationships of the Del_PathIDi and other CIDs except for the list of the CIDs in the route update message are deleted, Step 620 is performed; otherwise, Step 621 is performed.

In Step 620, the corresponding relationship between the Del_PathIDi and other CIDs except for each Keep_CID in the list of the CIDs in the route update message are deleted, and Step 622 is performed.

In Step 621, the corresponding relationships of the Del_PathIDi and all the CIDs in the route database are deleted.

In Step 622, it is judged whether the Del_PathIDi corresponds to the null RSID domain or not, and if the Del_PathIDi does not correspond to the null RSID domain, Step 624 is performed.

In Step 623, the acknowledgment response on the Del_PathIDi is added to the route update message.

In Step 624, it is set that i=i+1, and if i<=the number of the paths to be added Del_Path_Num, Step 614 is performed; otherwise, the flow is end.

It should be noted that, according to the route of the user terminal to be changed, the BS may transmits the MPDU corresponding to the same connection of the user terminal on different multi-hop paths, or transmits the MPDUs corresponding to the different connections of the user terminal on the different multi-hop paths.

The route update process of the present disclosure is described with the example.

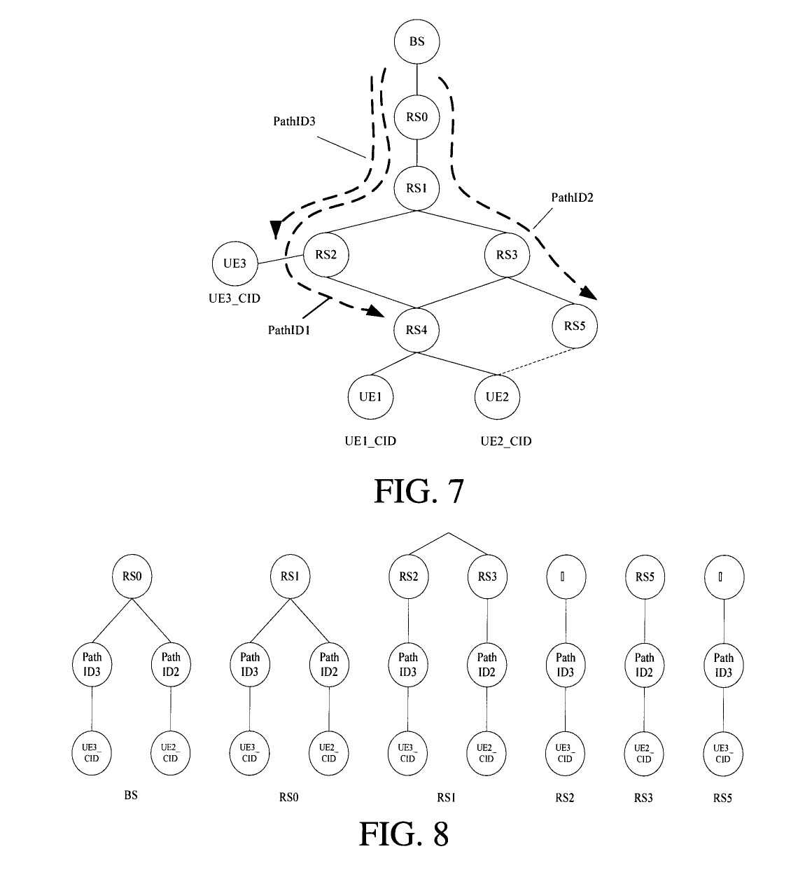

In FIG. 7, in this embodiment, BS is connected to RS0, RS0 is connected to RS1, RS1 is connected to RS2 and RS3, RS2 is connected to RS4, and RS3 is connected to RS4 and RS5. RS2 is connected to UE3, UE1 is connected to RS4, and RS4 is connected to RS5 and UE2. Further, from the BS, the RS0, the RS1, to the RS2 is the path 3 corresponding to the PathID3, from the BS, the RS0, the RS1, the RS2, to the RS4 is the path 1 corresponding to the PathID1, and from the BS, the RS0, the RS1, the RS3, to the RS5 is the path 2 corresponding to the PathID2. Further, the CIDs of UE1, UE2, and UE3 are respectively UE1_CID, UE2_CID, and UE3_CID.

In the topology structure as shown in FIG. 7, it is assumed that the BS sends the route update message for twice, and establishes the three paths as shown in the FIG. 7. For the first time, the BS establishes the PathID3 for the UE3_CID and establishes the PathID2 for the UE2_CID, and for the second time, the BS establishes the PathIDi for the UE1_CID and the UE2_CID. The UE2_CID has two paths.

The first route update message generated by the BS is as shown in Table 4, and the message is borne by the CID of the RS0.

Referring to Table 4, the route update message generated by the BS includes the operation serial number, the route update indication, the number of the paths to be added and the path IDs to be added, the CIDs to be added in each route, and the ordered set of the next hop RSs that the path passes.

TABLE 4

| | | |
|---|---|---|
| Message Type = RtUpdateCode | 8 | |
| Transaction ID | 16 | The operation serial number |
| Route_Update_Indicator = 0b01 | 2 | The route update indication is the newly |
| | | added path |
| Add_Path_Num = 2 | 4 | The number of the paths to be added |
| { | | |
| Add_Path_Indicator = 0b10 | 2 | Including the newly added path |
| Add_PathID = PathID3 | 8 | The newly added path ID PathID3 |
| Add_CID_Num = 1 | 4 | The number of the newly added CID is 1 |
| CID List = {UE3_CID} | 16 | The list of the newly added CIDs includes |
| | | UE3_CID |
| Add_RSID_Num = 2 | 4 | The number of newly added RSIDs is 2 |
| RSID List = {RS1_ID, RS2_ID} | 6 × 2 | The list of newly added RSIDs includes |
| | | RS1_ID and RS2_ID |
| } | | |
| { | | |
| Add_Path_Indicator = 0b10 | 2 | Including the newly added path |
| Add_PathID = PathID2 | 8 | Newly added path ID PathID2 |
| Add_CID_Num = 1 | 4 | The number of the newly added CID is 1 |
| CID List = {UE2_CID} | 16 | The list of the newly added CID includes the |
| | | UE2_CID |
| Add_RSID_Num = 3 | 4 | The number of the newly added RSIDs is 3 |
| RSID List = {RS1_ID, RS3_ID | 6 × 3 | The list of the RSIDs includes RS1_ID, |
| RS5_ID} | | RS3_ID, and RS5_ID |
| } | | |
| Padding bits | | The padding bits enable the whole message |
| | | length to become the integral byte |

After receiving the message sent from the BS, the RS0 updates the route database thereof, and generates the new route update message. The new route update message includes the operation serial number, the route update indication, the number of the paths to be added and the path ID to be added, the CID to be added in each route, and the ordered set of the next hop RSs that the path passes. A format of the route update message is as shown in Table 5, and the message is borne by the CID of the RS1.

TABLE 5

| | | |
|---|---|---|
| Message Type = RtUpdateCode | 8 | |
| Transaction ID | 16 | The operation serial number |
| Route_Update_Indicator = 0b01 | 2 | The route update indication is the newly added |
| | | path |
| Add_Path_Num = 2 | 4 | The number of the paths to be added |
| { | | |
| Add_Path_Indicator = 0b10 | 2 | Including the newly added path |
| Add_PathID = PathID3 | 8 | The newly added path ID PathID3 |
| Add_CID_Num = 1 | 4 | The number of the newly added CID is 1 |
| {UE3_CID} | 16 | The list of the newly added CIDs includes |
| | | UE3_CID |
| Add_RSID_Num = 1 | 4 | The number of newly added RSIDs is 1 |
| {RS2_ID} | 6 × 1 | The list of newly added RSIDs includes RS2_ID |
| } | | |
| { | | |
| Add_Path_Indicator = 0b10 | 2 | Including the newly added path |
| Add_PathID = PathID2 | 8 | Newly added path ID PathID2 |
| Add_CID_Num = 1 | 4 | The number of the newly added CID is 1 |
| {UE2_CID} | 16 | The list of the newly added CID includes the |
| | | UE2_CID |
| Add_RSID_Num = 2 | 4 | The number of the newly added RSIDs is 2 |
| {RS3_ID, RS5_ID} | 6 × 2 | The list of the RSIDs includes RS3_ID and |
| | | RS5_ID |
| } | | |
| Padding bits | | The padding bits enable the whole message |
| | | length to become the integral byte |

After receiving the route update message sent from the RS0, the RS1 updates the route database thereof. The path in the route update message is divaricated, that is, the next hop RS includes the RS2 and the RS3. Therefore, one new route update message is generated for each divarication, and the formats of the generated new route update message are respectively as shown in Tables 6 and 8, in which the route update message as shown in Table 6 is borne by the CID of the RS2.

TABLE 6

| | | |
|---|---|---|
| Message Type = RtUpdate | 8 | |
| Transaction ID | 16 | The operation serial number |
| Route_Update_Indicator = | 2 | Including the newly added path, but not |
| 0b01 | | including the deleted path |
| Add_Path_Num = 1 | 4 | The number of the paths to be added |
| { | | |
| Add_Path_Indicator = | 2 | The added path is the new path, and the |
| 0b00 | | original path ID is not utilized and the |
| | | detailed path information is not included |
| Add_PathID = PathID3 | 8 | The newly added route is PathID3 |
| Add_CID_Num = 1 | 4 | |
| CID List = {UE3_CID} | 16 | The list of the newly added CIDs |
| | | includes UE3_CID |
| } | | |
| Padding bits | | The padding bits enable the whole |
| | | message length to become the |
| | | integral byte |

After receiving the message, the RS2 needs to generate the route update feedback message, and the format of the message is as shown in FIG. 7.

TABLE 7

| | Bits | Comments |
|---|---|---|
| Message Type = | 8 | |
| RtUpdateFeedback | | |
| Transaction ID | 8 | The operation serial number |
| RtUpdate_Feedback_Indicator = | 2 | Including the newly added |
| 0b01 | | path feedback |
| Add_Path_Num = 1 | 4 | The feedback message |
| | | includes the number of the |
| | | paths |
| { | | |
| Add_PathID = PathID3 | 8 | The newly added route is |
| | | PathID3 |
| Add_Status = 0b01 | 1 | 1-ACK, 0-NAK |
| } | | |
| Padding bits | | The padding bits enable the |
| | | whole message length to |
| | | become the integral byte |

The route update message as shown in Table 8 is borne by the CID of the RS3.

TABLE 8

| | | |
|---|---|---|
| Message Type = RtUpdate | 8 | |
| Transaction ID | 16 | The operation serial number |
| Route_Update_Indicator = 0b01 | 2 | Including the newly added path, and not |
| | | including the deleted path |
| Add_Path_Num = 1 | 4 | The number of the paths to be added |
| { | | |
| Add_Path_Indicator = 0b10 | 2 | |
| Add_PathID = PathID2 | 8 | The newly added route is PathID2 |
| Add_CID_Num = 1 | 4 | The number of the newly added CIDs |
| CID List = {UE2_CID} | 16 | The list of the newly added CIDs includes |
| | | UE2_CID |
| Add_RSID_Num = 1 | 4 | The number of the newly added RSIDs is 1 |
| RSID_List = {RS5_ID} | 6 × 1 | The list of the newly added RSIDs includes |
| | | RS5_ID |
| } | | |
| Padding bits | | The padding bits enable the whole message |
| | | length to become the integral byte |

After receiving the route update message, similarly, the RS3 updates the route database thereof by utilizing the route update message, generates the new route update message, and sends the new route update message to the RS5. After receiving the route update message, the RS5 updates the corresponding route database thereof by utilizing the received route update message, and then sends the route update acknowledgement message to the BS.

Referring to FIG. 8, after the first time of the route update, the route database of each RS of the BS is as follows.

In the route database corresponding to the BS, the next hop RSID in the next hop RSID domain is the RS0, the path ID domain saves the two paths passing the RS0, which are respectively the PathID2 and the PathID3, and the CID domain stores the UE3_CID corresponding to the path ID being the PathID3 and the UE2_CID corresponding to the path ID being the PathID2.

In the route database corresponding to the RS0, the next hop RSID in the next hop RSID domain is the RS1, the path ID domain saves two paths passing the RS1, which are respectively the PathID2 and the PathID3, and the CID domain stores the UE3_CID corresponding to the path ID being the PathID3 and the UE2_CID corresponding to the path ID being the PathID2.

In the route database corresponding to the RS1, the next hop RSID in the next hop RSID domain includes the RS2 and the RS3, the path ID domain saves one paths passing the RS2, i.e., the PathID3, and also saves one path passing the RS3, i.e., the PathID2, and the CID domain stores the UE3_CID corresponding to the path ID being the PathID3 and the UE2_CID corresponding to the path ID being the PathID2.

In the route database corresponding to the RS2, the next hop RSID in the next hop RSID domain is null, the path ID domain saves one path passing the RS2, i.e., the PathID3, and the CID domain stores the UE3_CID corresponding to the path ID being the PathID3.

In the route database corresponding to the RS3, the next hop RSID in the next hop RSID domain is the RS5, the path ID domain saves one path passing the RS3, i.e., the PathID2, and the CID domain stores the UE2_CID corresponding to the path ID being the PathID2.

In the route database corresponding to the RS5, the next hop RSID in the next hop RSID domain is null, the path ID domain saves one path passing the RS5, i.e., the PathID3, and the CID domain stores the UE3_CID corresponding to the path ID being the PathID3.

Table 9 shows the second route update message generated by the BS.

TABLE 9

| | | |
|---|---|---|
| Message Type = RtUpdate | 8 | |
| Transaction ID | 16 | The operation serial number |
| Route_Update_Indicator = 0b01 | 4 | Including the newly added path, and not |
| | | including the deleted path |
| Add_Path_Num = 1 | 4 | The number of the paths to be added |
| { | | |
| Add_Path_Indicator = 0b11 | 2 | The added path is the new path, utilizes |
| | | the original path ID and includes the |
| | | detailed path information |
| Add_PathID = PathID1 | 8 | The newly added path ID is PathID1 |
| Add_CID_Num = 2 | 4 | The number of the newly added CIDs |
| CID List = {UE1_CID, UE2_CID} | 16 × 2 | The list of newly added CIDs includes |
| | | UE1_CID and UE2_CID |
| Overlapped_PathID = PathID3 | 8 | The overlapped path is PathID3 |
| Add_RSID_Num = 1 | 4 | The number of the newly added RSIDs |
| RSID List = {RS4_ID} | 6 | The list of the newly added RSIDs |
| } | | |
| Padding bits | | The padding bits enable the whole |
| | | message length to become the integral |
| | | byte |

The route update message as shown in Table 9 is different from the route update message as shown in Table 4 that the new path includes the overlapped path, but the processing principle is similar.

After the BS sends the route update message to the RS0, the RS0 updates the route database thereof, and generates and sends the new route update message to the next hop RS. The route update message generated by the RS0 and the RS1 are wholly the same as the content of the route update message of the BS, only the CIDs of the RSs bearing the message are different. After the message is sent to the RS2, the path corresponding to the PathID3 is terminated. The format of the new route update message generated by the RS2 is shown in Table 10, and the message is borne by the CID of the RS4.

TABLE 10

| | | |
|---|---|---|
| Message Type = RtUpdate | 8 | |
| Transaction ID | 16 | The operation serial number |
| Route_Update_Indicator = 0b01 | 4 | Including the newly added path, and not |
| | | including the delete path |
| Add_Path_Num = 1 | 4 | The number of the paths to be added |
| { | | |
| Add_Path_Indicator = 0b00 | 2 | The added path is the new path, does |
| | | not utilize the original path ID and does |
| | | not include the detailed path |
| | | information |
| Add_PathID = PathID1 | 8 | The newly added path ID is PathID1 |
| Add_CID_Num = 2 | 4 | The number of the newly added CIDs is 2 |
| CID List = {UE1_CID, UE2_CID} | 16 × 2 | The list of the newly added CIDs |
| | | includes UE1_CID and UE2_CID |
| } | | |
| Padding bits | | The padding bits enable the whole |
| | | message length to become the integral |
| | | byte |

After receiving the message, the RS4 generates and sends the route update feedback message to the BS.

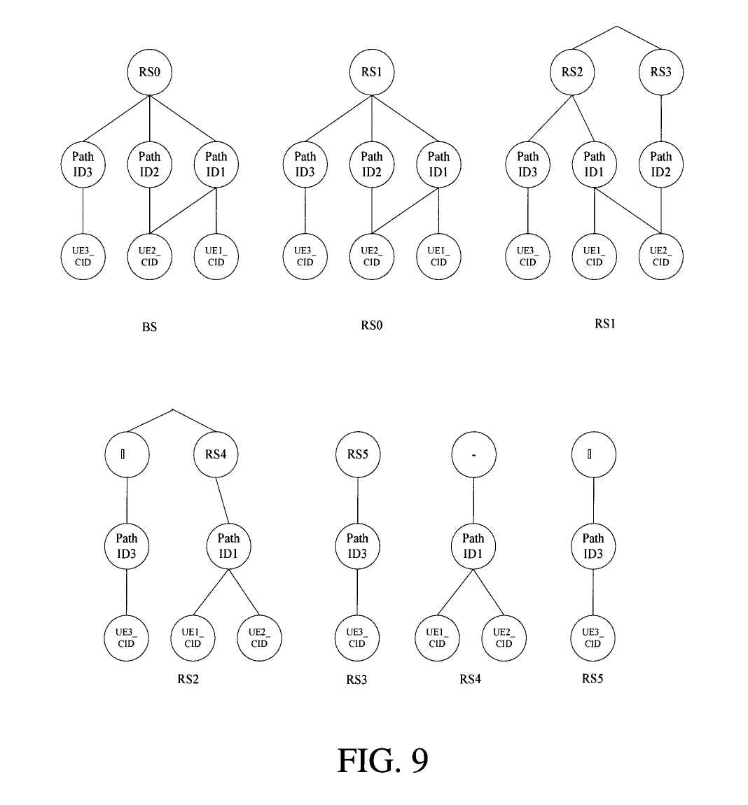

Referring to FIG. 9, after the second time of the route update, the route database of each RS of the BS is as follows.

In the route database corresponding to the BS, the next hop RSID in the next hop RSID domain is the RS0, the path ID domain saves the three paths passing the RS0, which are respectively PathID1, PathID2 and the PathID3, and the CID domain stores the UE3_CID corresponding to the path ID being the PathID3, the UE3_CID corresponding to the path ID being the PathID2, and the UE2_CID and the UE1_CID corresponding to the path ID being the PathID1.

In the route database corresponding to the RS0, the next hop RSID in the next hop RSID domain is the RS1, the path ID domain saves three paths passing the RS1, which are respectively PathID1, PathID2 and the PathID3, and the CID domain stores the UE3_CID corresponding to the path ID being the PathID3, the UE3_CID corresponding to the path ID being the PathID2, and the UE2_CID and the UE1_CID corresponding to the path ID being the PathID1.

In the route database corresponding to the RS1, the next hop RSID in the next hop RSID domain includes the RS2 and the RS3, the path ID domain saves three paths passing the RS2, which are respectively PathID1 and PathID2, and also saves one path passing the RS3, i.e., the PathID3, and the CID domain stores the UE3_CID corresponding to the path ID being the PathID3, the UE3_CID corresponding to the path ID being the PathID2, and the UE2_CID and the UE1_CID corresponding to the path ID being the PathID1.

In the route database corresponding to the RS2, the next hop RSID in the next hop RSID domain is the RS4, the path ID domain saves one path passing the RS4, i.e., the PathID1, and also saves one path passing the RS2, i.e., the PathID3, and the CID domain stores the UE3_CID corresponding to the path ID being the PathID3 and the UE2_CID and the UE1_CID corresponding to the path ID being the PathID1.

In the route database corresponding to the RS3, the next hop RSID in the next hop RSID domain is the RS5, the path ID domain saves one path passing the RS3, i.e., the PathID2, and the CID domain stores the UE2_CID corresponding to the path ID being the PathID2.

In the route database corresponding to the RS4, the next hop RSID in the next hop RSID domain is null, the path ID domain saves one path passing the RS4, i.e., the PathID1, and the CID domain stores the UE2_CID and the UE1_CID corresponding to the path ID being the PathID1.

In the route database corresponding to the RS5, the next hop RSID in the next hop RSID domain is null, the path ID domain saves one path passing the RS5, i.e., the PathID3, and the CID domain stores the UE3_CID corresponding to the path ID being the PathID3.

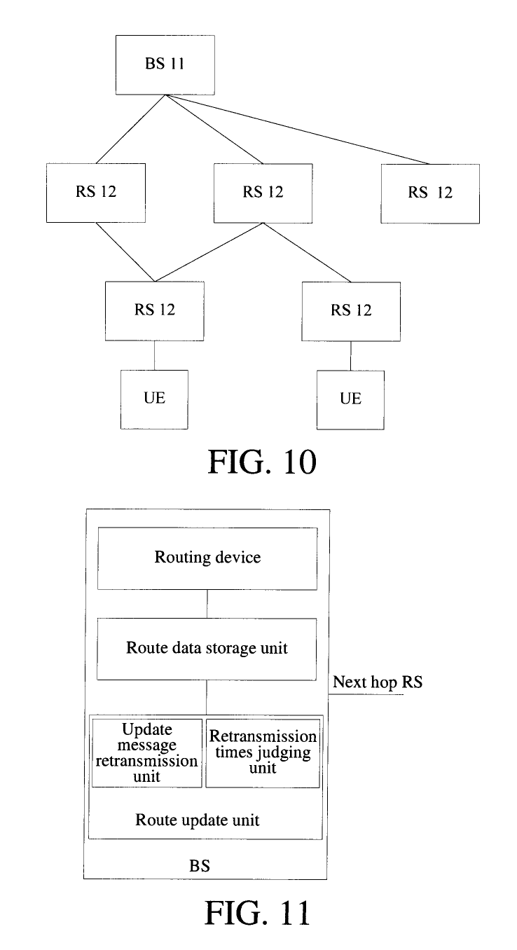

Referring to FIG. 10, the multi-hop wireless relay system of one embodiment of the present disclosure includes a BS 11 and more than one RS 12. Each network unit saves the route database storing the corresponding relationship of the CID and the path ID and the corresponding relationship of the path ID and the next hop RS.

The BS 11 is adapted to search in the route database of itself according to the CID in the downlink MPDU header to be sent to the user terminal, obtain the corresponding next hop RSID, and send the downlink MPDU to the next hop RS. The RS 12 is adapted to search in the corresponding route database according to the CID in the received downlink MPDU header, obtain the corresponding next hop RSID, and send the downlink MPDU to the next hop network unit accordingly.

Referring to FIG. 11, in one embodiment of the present disclosure, the BS includes a routing device, adapted to obtain the next hop RSID corresponding to the CID in the downlink MPDU header to be sent according to the corresponding relationship of the CID and the next hop RSID, and send the downlink MPDU to the next hop RS by utilizing the obtained next hop RSID.

The BS further includes a route data storage unit, adapted to store the corresponding relationship of the CID and the next hop RSID.

The route data storage unit includes a next hop RSID domain adapted to store the next hop RSID, a path ID domain saving the path ID, and a CID domain saving the CID. The corresponding relationship of the CID and the next hop RSID may be represented as: each CID corresponds to at least one path ID, and each path ID corresponds to one next hop RSID.

The BS further includes a route update unit, adapted to generate the route update message when the route update triggering condition is satisfied, update the route data storage unit by utilizing the route update message, and send the route update message to the next hop RS.

The route update unit further includes an update message retransmission unit, adapted to start a route update timer when sending the route update message to the next hop RS, and stop the route update timer of itself after receiving the route update acknowledgement message from the next hop RS; and send the route update message again and meanwhile start the route update timer again, when the route update timer overflows and the route update acknowledgement message is not received.

The update message retransmission unit further includes a retransmission times judging unit, adapted to record a retransmission times, and judge whether the retransmission times exceeds a maximum retry times when the route update timer overflows and the route update acknowledgement message is not received, if the retransmission times does not exceed the maximum retry times, then send the route update message again.

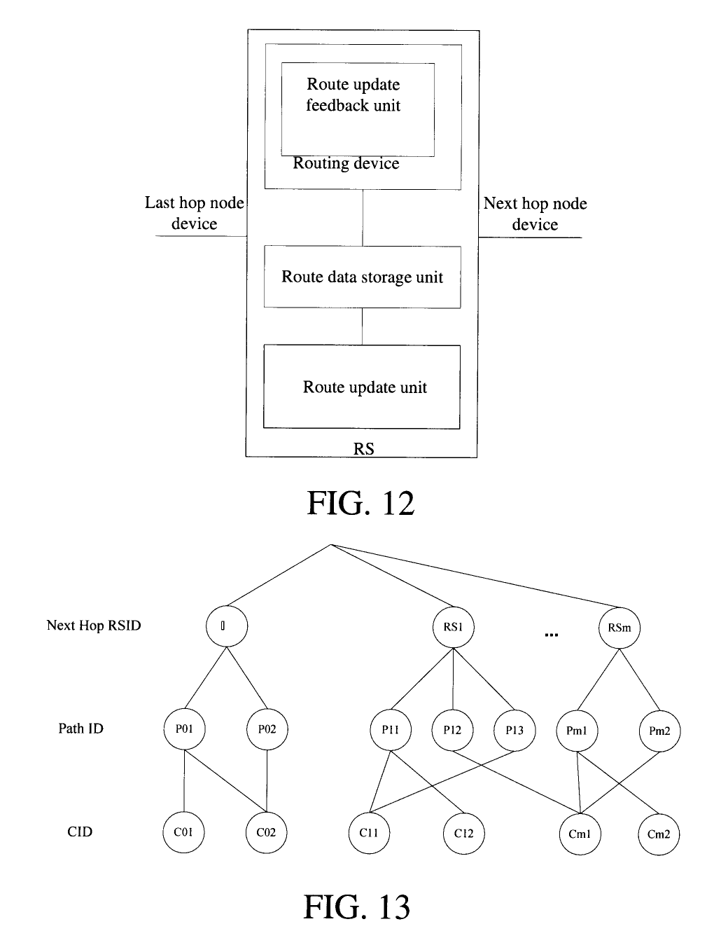

Referring to FIG. 12, in one embodiment of the present disclosure, the RS may include a routing device, adapted to search in the corresponding route database thereof according to the CID in the received downlink MPDU, obtain the corresponding next hop RSID, and send the downlink MPDU to the next network unit accordingly. When the next hop RSID is null, the next network unit is the user terminal.

The routing device further includes a route update feedback unit, adapted to generate the route update acknowledgement message when the next hop RSID is null, and send the route update acknowledgement message to the destination hop RS.

The RS further includes a route data storage unit, adapted to store the corresponding relationship of the CID and the next hop RSID. Here, the route data storage unit includes a next hop RSID domain adapted to store the next hop RSID, a path ID domain saving the path ID, and a CID domain saving the CID. The stored corresponding relationship of the CID and the next hop RSID includes that each CID corresponds to at least one path ID, and each path ID corresponds to one next hop RSID.

The RS further includes a route update unit, adapted to generate a new route update message according to the route information except for this hop in the route update message from the destination hop network, and send the new route update message to the next hop RS.

The route update message includes the route update message type, the operation serial number, and the route update indication information. The route update indication information includes the path ID passing the next hop RS to be added or deleted, and the CID corresponding to each path ID.

In the system of the embodiment of the present disclosure, the route update message includes the route update message type, the operation serial number, and the route update indication information. The route update indication information includes the path ID passing the next hop RS to be added or deleted, and the CID corresponding to each path ID.

The route update acknowledgement message includes the route update feedback message type, the operation serial number, and the route update feedback indication information. The route update feedback indication information includes the path ID passing the next hop RS to be added or deleted, and/or the operation result of the CID corresponding to each path ID.

For the uplink data transmission process in the multi-hop relay communication system, the method similar to the downlink data transmission of the present disclosure may be adopted, that is, the structure of the used route database is the same as that of the route database used by the downlink data transmission, and the method for realizing the uplink data is similar.

From the above technical solution, it may be known that the embodiments of the present disclosure support the data transmission of the multi-hop wireless communication system without changing the current user terminal and the protocol structure of the core network.

(2) During the multi-hop transmit process, the original MPDU is not additionally encapsulated, so as to save the cost of the air interface.

(3) In the present disclosure, the route searching process performed by the RS on the MPDU may be realized via hardware, thus achieving a rapid forwarding speed.

(4) The same connection may be transmitted via the plurality of path, which is used for macro diversity and increase of the reliability of the link.

(5) The different connections of the same terminal may be transmitted via different paths, which are used for load balance and increase of the throughput.

It will be apparent to those skilled in the art that various modifications and variations can be made to the structure of the present invention without departing from the scope or spirit of the invention. In view of the foregoing, the present invention is intended to cover modifications and variations of this invention provided they fall within the scope of the following claims and their equivalents.

What is claimed is:

1. A downlink data transmitting method, comprising:
obtaining, by a network unit, an identifier (ID) of a next hop network unit corresponding to a connection identifier (CID) in a downlink medium access control protocol data unit (MPDU) header according to an existing corresponding relationship of the CID and a path ID; and
sending the downlink MPDU to the next hop network unit by utilizing the obtained ID of the next hop network unit.

2. The method according to claim 1, wherein the network unit comprises a base station (BS) and one or more relay stations (RSs), the BS and each RS respectively corresponding to a route database adapted to save the corresponding relationship of the CID and the path ID.

3. The method according to claim 2, further comprising:
generating, by the BS, a route update message when determining that a route update triggering condition is satisfied, initiating a route update process by utilizing the route update message;
wherein the determining that the route update triggering condition is satisfied comprises:
determining whether a connection of a user terminal corresponding to the downlink MPDU is changed or not, and if the connection of the user terminal corresponding to the downlink MPDU is changed, determining that the update triggering condition is satisfied;
otherwise, determining that the route update triggering condition is not satisfied.

4. The method according to claim 3, wherein the updating the route databases corresponding to the BS and the RSs comprises:
sending, by the BS, the route update message to a next hop RS, and updating the route database corresponding to itself by utilizing the route update message, wherein the route update message comprises information of the next hop RS till a destination station where the connection of the user terminal passes; and
updating, by the RS receiving the route update message, the route database corresponding to itself by utilizing the received route update message, deleting information about the RS itself in the received route update message, and generating a new route update message to send to the next hop RS, till the destination station.

5. The method according to claim 4, further comprising:
generating, by the destination station, a route update acknowledgement message which indicating a routing update result, after receiving the route update message, and sending the route update acknowledgement message to the BS.

6. The method according to claim 4, wherein the route database comprises a next hop network unit ID domain saving the ID of the next hop network unit, a path ID domain saving a path ID, and a CID domain saving the CID.

7. The method according to claim 6, wherein the route update message comprises a route update message type, an operation serial number, and an route update indication, wherein the route update indication message comprises route information to be updated and/or a corresponding relationship of a path ID and the CID.

8. The method according to claim 7, wherein the route update indication comprises:
a number of paths to be added and a list of the paths to be added; and/or a number of the paths to be deleted and a list of the paths to be deleted; wherein
the list of the paths to be added comprises one or more of:
whether the added path is a new path or not, whether the new path is generated by utilizing the original path ID or not, the added path ID, a list of the CIDs having the same path, overlapped parts of the new path and the original path, a number of the newly added RSs, newly added network unit IDs; and
the list of the paths to be deleted comprises one or more of:
deleting the whole path ID, deleting the given CIDs in a given path, deleting all the
CIDs except for the given CIDs in the given path, deleting all the CIDs in the given path and reserving the path ID.

9. The method according to claim 5, wherein the route update acknowledgement message comprises a route update feedback message type, an operation serial number, and a route update feedback indication information, wherein
the route update feedback indication information comprises an operation result of the CID corresponding to each path ID, if the route update fails, the route update feedback information further comprises an error code; and
the operation serial number is the same as the operation serial number of the route update message.

10. The method according to claim 9, wherein the route update feedback indication information comprises feedback information on newly added paths and/or feedback information on deleted paths; wherein
the feedback information on the newly added paths comprises a number of the paths, the path IDs, and feedback information on each CID in the route update message; and
the feedback information on the deleted paths comprises a number of the paths, the path IDs, and feedback information on each CID in the route update message.

11. The method according to claim 4, wherein if the network unit receiving the route update message determines that a plurality of next hop network units exists according to the route update message, the network unit deletes the information about itself from the original route update message to generate a plurality of different route update messages, and sends the route update messages to each corresponding next hop network unit, and an operation serial number of each generated route update message is the same as the serial number of the original route update message.

12. The method according to claim 4, wherein the updating, by the BS, the route database corresponding to itself by utilizing the route update message comprises:
determining, by the BS, whether the update of this time is an route adding operation or a deletion operation according to the route update message;
judging, by the BS, whether the route update message comprises the newly added paths or not if the update is the adding operation, and if the route update message comprises the newly added paths, adding the newly added paths to the route database corresponding to itself; and
judging, by the BS, whether the route update message comprises the paths to be deleted or not if the update is the deletion operation, and if the route update message comprises the paths to be deleted, deleting related paths in the route database corresponding to itself according to the route update message.

13. The method according to claim 4, wherein the updating, by the RS receiving the route update message, the route database corresponding to itself comprises:
determining, by the RS, whether the update of this time is an route adding operation or a deletion operation according to the route update message;
judging whether the route update message comprises the newly added paths or not if the update is the adding operation, and if the route update message comprises the newly added paths, adding the newly added paths to the route database corresponding to itself; and
judging whether the route update message comprises the paths to be deleted or not if the update is the deletion operation, and if the route update message comprises the paths to be deleted, deleting related paths in the route database corresponding to itself according to the route update message.

14. The method according to claim 4, wherein the generating the route update message comprises:
if the paths of different route update messages pass the same next hope network unit, the multiple route update messages are aggregated into one message, otherwise, separated route update messages are generated for each corresponding next hope network unit.

15. The method according to claim 6, wherein information in a next hop network unit domain comprises one or more IDs of the next hop network unit;
when a next hop RS domain comprises a plurality of IDs of the next hop network unit, the sending, by the network unit, the downlink MPDU packet to the next hop network unit comprises:
broadcasting the downlink MPDU by utilizing the plurality of IDs of the next hop network unit as a broadcasting group.

16. A multi-hop wireless relay system, comprising a base station (BS) and more than one relay station (RS), wherein
the BS is adapted to obtain a next hop relay station identifier (RSID) corresponding to a connection ID (CID) in a downlink medium access control protocol data unit (MPDU) according to an existing corresponding relationship of the CID and the next hop RSID, and send the downlink MPDU to the next hop RS according to the obtained next hop RSID; and
the RS is adapted to obtain a next hop RSID corresponding to a CID in a received downlink MPDU header according to the existing corresponding relationship of the CID and the next hop RSID, and send the downlink MPDU to the next hop RS till a user terminal according to the obtained next hop RSID.

17. The system according to claim 16, wherein the corresponding relationship of the CID and the next hop RS comprises:
a corresponding relationship of the CID and a path ID, and a corresponding relationship of the path ID and the next hop RS.

18. A communication device, applied to a multi-hop wireless relay system, the communication device is a base station (BS) or a relay station (RS), comprising:
a routing device, adapted to obtain an identifier (ID) of a next hop network unit corresponding to a connection ID (CID) in a downlink medium access control protocol data unit (MPDU) header according to an existing corresponding relationship of the CID and a path ID, and send the downlink MPDU to the next hop network unit by utilizing the obtained ID of the next hop network unit.

19. The communication device according to claim 18, wherein the communication device further comprises:
a route data storage unit, adapted to save a corresponding relationship of the CID and a path ID, and a corresponding relationship of the path ID and the ID of the next hop network unit.

20. The communication device according to claim 19, wherein the route data storage unit comprises:
an ID of the next hop network unit domain adapted to store the ID of the next hop network unit, a path ID domain saving the path ID, and a CID domain saving the CID.

21. The communication device according to claim 18, further comprising:
a route update unit, adapted to generate a route update message when a route update triggering condition is satisfied, update the route data storage unit by utilizing the route update message, and send the route update message to the next hop network unit.

22. The communication device according to claim 21, wherein the route update unit further comprises:
an update message retransmission unit, adapted to start a route update timer when sending the route update message to the next hop network unit, stop the route update timer thereof after receiving a route update acknowledgement message, and send the route update message again and meanwhile start the route update timer again when the route update timer overflows but the route update acknowledgement message is not received.

23. The communication device according to claim 22, wherein the update message retransmission unit further comprises:
a retransmission times judging unit, adapted to record a retransmission times, and judge whether the retransmission times exceeds a maximum retry times when the route update timer overflows and the route update acknowledgement message is not received, and send the route update message again if the retransmission times does not exceed the maximum retry times.
